(19) United States
(12) Patent Application Publication
(10) Pub. No.: US 2026/0253158 A1
(43) Pub. Date: Aug. 27, 2026

(54) PASSENGER FLOW PREDICTION METHOD, MODEL TRAINING METHOD, ELECTRONIC DEVICE AND READABLE MEDIUM

(71) Applicant: CRSC COMMUNICATION & INFORMATION GROUP COMPANY LTD., Beijing (CN)

(72) Inventors: Jing LUO, Beijing (CN); Peiran LI, Beijing (CN); Yupeng GUO, Beijing (CN); Shaojiang MAO, Beijing (CN); Xiao WANG, Beijing (CN); Qingqing LEI, Beijing (CN); Feng REN, Beijing (CN)

(21) Appl. No.: 18/995,340

(22) PCT Filed: Jun. 25, 2023
(86) PCT No.: PCT/CN2023/102179

§ 371 Date: Jan. 16, 2025

(30) Foreign Application Priority Data
Aug. 3, 2022 (CN) 202210926671.5

(51) Int. Cl. G06Q 50/40; G06N 20/00; G06Q 10/04

(52) U.S. Cl. CPC G06Q 50/40; G06N 20/00; G06Q 10/04

(57) ABSTRACT

Provided in the present disclosure are a passenger flow prediction method, a model training method, an electronic device and a readable medium. The passenger flow prediction method includes: generating a passenger flow matrix according to passenger flows of a station in an urban rail transit line from a 1st statistical moment to an N^{th} statistical moment; performing a first convolution operation and a first full connection operation on the passenger flow matrix in the spatial dimensions to obtain spatial feature information; performing a second convolution operation and a second full connection operation on the passenger flow matrix in the time dimension to obtain temporal feature information; and performing a third full connection operation and normalization on the spatial feature information and the temporal feature information, to obtain predicted data of the spatial dimensions corresponding to an (N+1)^{th} statistical moment, outputting a predicted passenger flow at the (N+1)^{th} statistical moment.

### TECHNICAL FIELD

Embodiments of the present disclosure relate to the technical field of artificial intelligence, and particularly relate to passenger flow prediction method, a model training method, an electronic device and a readable medium.

### BACKGROUND

There are many passenger flow variables, which are generally used as indicators for current monitoring and future prediction of a passenger flow state. According to sizes of prediction time windows, passenger flow prediction is roughly divided into two scales: short term prediction (5 to 30 minutes), and medium and long term prediction (more than 30 minutes). Meanwhile, passenger activities have many uncertainties. In a subway station, technicians can only obtain fuzzy passenger flow conditions from attributes of passengers entering and leaving the station, which also increases the difficulty for prediction.

Current prediction methods have the defects of relatively large prediction errors, high requirement on data sets or low model adaptability.

### SUMMARY

Embodiments of the present disclosure provide a passenger flow prediction method, a model training method, an electronic device and a readable medium.

In a first aspect, an embodiment of the present disclosure provides a passenger flow prediction method, including:
acquiring passenger flows of a station in an urban rail transit line from a 1st statistical moment to an N^{th} statistical moment;
inputting the passenger flows from the 1st statistical moment to the N^{th} statistical moment into a trained passenger flow prediction model, to obtain a predicted passenger flow of the station in the urban rail transit line at an (N+1)^{th} statistical moment;
wherein the passenger flow prediction model performs the processing of:
generating a passenger flow matrix according to the passenger flows from the 1st statistical moment to the N^{th} statistical moment, wherein a first dimension of the passenger flow matrix is a time dimension, and a second dimension and a third dimension of the passenger flow matrix are spatial dimensions, and positions of the passenger flows of the station in the spatial dimensions represent a connection relationship of stations, where N is an integer greater than or equal to 2;
performing a first convolution operation and a first full connection operation on the passenger flow matrix in the spatial dimensions to obtain spatial feature information;
performing a second convolution operation and a second full connection operation on the passenger flow matrix in the time dimension to obtain temporal feature information; and
performing a third full connection operation and normalization on the spatial feature information and the temporal feature information, to obtain predicted data of the spatial dimensions corresponding to an (N+1)^{th} statistical moment, and outputting, according to the predicted data of the spatial dimensions corresponding to the (N+1)^{th} statistical moment, the predicted passenger flow of the station in the urban rail transit line at the (N+1)^{th} statistical moment.

In some exemplary embodiments, generating the passenger flow matrix according to the passenger flows from the 1st statistical moment to the N^{th} statistical moment includes:
generating a two-dimensional first matrix corresponding to a j^{th} statistical moment according to the passenger flow of the station in the urban rail transit line at the j^{th} statistical moment, where j is an integer between 1 and N; and
splicing two-dimensional first matrixes corresponding to all the statistical moments into the passenger flow matrix in the time dimension.

In some exemplary embodiments, performing the first convolution operation and the first full connection operation on the passenger flow matrix in the spatial dimensions to obtain spatial feature information includes:
performing the first convolution operation X times and a first activation function operation X times on the passenger flow matrix in the spatial dimensions to obtain X first convolution operation results, where X is an integer greater than or equal to 2;
converting each first convolution operation result into a one-dimensional first vector;
splicing X first vectors into a one-dimensional second vector; and
performing the first full connection operation and the first activation function operation on the second vector to obtain the spatial feature information.

In some exemplary embodiments, performing the first convolution operation X times and the first activation function operation X times on the passenger flow matrix in the spatial dimensions to obtain X first convolution operation results includes:
performing the first convolution operation for the first time and the first activation function operation for the first time on the passenger flow matrix in the spatial dimensions to obtain a first convolution operation result for the first time; and
performing the first convolution operation for the (i+1)^{th} time and the first activation function operation for the (i+1)^{th} time on a first convolution operation result for the i^{th} time to obtain a first convolution operation result for the (i+1)^{th} time, where i is an integer between 1 and X−1.

In some exemplary embodiments, performing the second convolution operation and the second full connection operation on the passenger flow matrix in the time dimension to obtain temporal feature information includes:
converting the passenger flow matrix into a two-dimensional second matrix under the condition of ensuring that the time dimension is unchanged;
performing the second convolution operation X times and the first activation function operation X times on the second matrix to obtain X second convolution operation results;
converting each second convolution operation result into a one-dimensional third vector;
splicing X third vectors into a one-dimensional fourth vector; and
performing the second full connection operation and the first activation function operation on the fourth vector to obtain the temporal feature information.

In some exemplary embodiments, performing the second convolution operation X times and the first activation function operation X times on the second matrix to obtain X second convolution operation results includes:
performing the second convolution operation for the first time and the first activation function operation for the first time on the second matrix to obtain a second convolution operation result for the first time; and
performing the second convolution operation for the (i+1)^{th} time and the first activation function operation for the (i+1)^{th} time on a second convolution operation result for the i^{th} time to obtain a second convolution operation result for the (i+1)^{th} time, where i is an integer between 1 and X−1.

In some exemplary embodiments, performing the third full connection operation and normalization on the spatial feature information and the temporal feature information, to obtain predicted data of the spatial dimensions corresponding to the (N+1)^{th} statistical moment includes:
splicing the spatial feature information and the temporal feature information into a one-dimensional fifth vector, and performing the third full connection operation and a first activation function operation on the fifth vector to obtain spatial-temporal feature information; and
performing normalization on the spatial-temporal feature information to obtain predicted data of the spatial dimensions corresponding to the (N+1)^{th} statistical moment.

In a second aspect, an embodiment of the present disclosure provides a model training method, including:
acquiring sample data, wherein the sample data includes: passenger flows of a station in an urban rail transit line at N+1 statistical moments;
performing model training by taking passenger flows at first N statistical moments in the sample data as input to a passenger flow prediction model and taking a passenger flow at an (N+1)^{th} statistical moment in the sample data as output of the passenger flow prediction model, to obtain a trained passenger flow prediction model,
wherein the passenger flow prediction model performs the processing of:
generating a passenger flow matrix according to passenger flows from a 1st statistical moment to an N^{th} statistical moment in the sample data, wherein a first dimension of the passenger flow matrix is a time dimension, and a second dimension and a third dimension of the passenger flow matrix are spatial dimensions, and positions of the passenger flows of the station in the spatial dimensions represent a connection relationship of stations, where N is an integer greater than or equal to 2;
performing a first convolution operation and a first full connection operation on the passenger flow matrix in the spatial dimensions to obtain spatial feature information;
performing a second convolution operation and a second full connection operation on the passenger flow matrix in the time dimension to obtain temporal feature information; and
performing a third full connection operation and normalization on the spatial feature information and the temporal feature information, to obtain predicted data of the spatial dimensions corresponding to an (N+1)^{th} statistical moment, and outputting, according to the predicted data of the spatial dimensions corresponding to the (N+1)^{th} statistical moment, the predicted passenger flow of the station in the urban rail transit line at the (N+1)^{th} statistical moment.

In a third aspect, an embodiment of the present disclosure provides an electronic device, including:
at least one processor; and
a memory having at least one program stored thereon which, when executed by the at least one processor, causes the at least one processor to implement any passenger flow prediction method or the model training method described above.

In a fourth aspect, an embodiment of the present disclosure provides a readable medium having a computer program stored thereon which, when executed by a processor, causes any passenger flow prediction method or the model training method described above to be implemented.

According to the passenger flow prediction method provided in the embodiments of the present disclosure, a passenger flow at a next statistical moment can be predicted based on passenger flows of a station at different statistical moments independent of other objective factors (such as weather, holidays and the like), so that the accuracy of model prediction is increased, the requirement on data sets is reduced, and the adaptability of the model is improved.

### BRIEF DESCRIPTION OF DRAWINGS

Accompanying drawings are provided for further understanding of the embodiments of the present disclosure and constitute a part of the specification. Hereinafter, these drawings are intended to explain the present disclosure together with the following embodiments, but should not be considered as a limitation to the present disclosure. Detailed exemplary embodiments are described with reference to the accompanying drawings, in which:

FIG. 1 is a flowchart of a passenger flow prediction method according to an embodiment of the present disclosure;

FIG. 2 is a schematic diagram illustrating data processing in a passenger flow prediction model according to an embodiment of the present disclosure;

FIG. 3 is a schematic diagram of performing a first convolution operation X times and a first activation function operation X times on the passenger flow matrix in the spatial dimensions to obtain X first convolution operation results according to an embodiment of the present disclosure;

FIG. 4 is a schematic diagram of performing a second convolution operation X times and a first activation function operation X times on the second matrix to obtain X second convolution operation results according to an embodiment of the present disclosure; and

FIG. 5 is a flowchart of a model training method according to another embodiment of the present disclosure.

### DETAIL DESCRIPTION OF EMBODIMENTS

To improve understanding of the technical solutions of the present disclosure for those skilled in the art, the passenger flow prediction method, the model training method, the electronic device and the readable medium of the present disclosure will be described below in detail in conjunction with the accompanying drawings.

Exemplary embodiments will be described more sufficiently below with reference to the accompanying drawings, but which may be embodied in different forms and should not be construed as limited to the embodiments set forth herein. Rather, these embodiments are provided so that the present disclosure will be thorough and complete, and will fully convey the scope of the present disclosure to those skilled in the art.

The embodiments of the present disclosure and features thereof may be combined with each other as long as they are not contradictory.

As used herein, the term “and/or” includes any and all combinations of at least one associated listed item.

The terminology used herein is for the purpose of describing specific embodiments only and is not intended to limit the present disclosure. As used herein, the singular forms “a”, “an” and “the” are intended to include the plural forms as well, unless the context clearly indicates otherwise. It will be further understood that as used herein, the terms “comprise” and/or “consist of . . . ” specify the presence of the stated features, integers, steps, operations, elements, and/or components, but do not preclude the presence or addition of at least one other feature, integer, step, operation, element, component, and/or group thereof.

Unless otherwise defined, all terms (including technical and scientific terms) used herein have the same meaning as commonly understood by one of ordinary skill in the art. It will be further understood that terms, such as those defined in commonly used dictionaries, should be interpreted as having a meaning that is consistent with their meaning in the context of the existing art and the present disclosure, and will not be interpreted in an idealized or overly formal sense unless expressly so defined herein.

Currently, a commonly used passenger flow prediction algorithm for an urban rail transit is a four-stage method in macroscopic passenger flow prediction methods. Later, as the urban rail transit network becomes denser and denser, the transfer relationship among lines will become more and more complex, leading to relatively large passenger flow prediction errors for a single-line rail transit. In this case, an idea of “total amount control” is generated, which means that a total passenger flow of the urban rail transit network is controlled in prediction, so as to achieve the purpose of reducing prediction errors. For short term passenger flow prediction, some researchers are trying to use a long short term memory (LSTM) network or a back propagation (BP) neural network to create a subway passenger flow prediction system considering influences of complex factors, and introduce factors such as weather, festivals, station types and the like for model modeling and prediction. However, these methods all undoubtedly improve the requirements on data sets while reducing adaptability of the model.

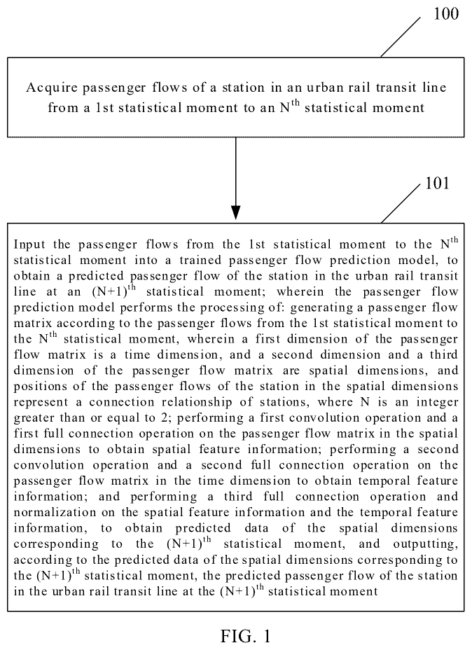

FIG. 1 is a flowchart of a passenger flow prediction method according to an embodiment of the present disclosure.

In a first aspect, referring to FIG. 1, an embodiment of the present disclosure provides a passenger flow prediction method, including the following steps 100 to 101:

At step 100, acquiring passenger flows of a station in an urban rail transit line from a 1st statistical moment to an N^{th} statistical moment.

In an embodiment of the present disclosure, the passenger flows at the N statistical moments used for predicting a passenger flow at an (N+1)^{th} statistical moment are all historical statistical passenger flows.

In some exemplary embodiments, a value of N may be determined according to actual conditions. For example, Nis 4.

In some exemplary embodiments, the passenger flow may be any one of an inbound passenger flow, an outbound passenger flow, or a sum of an inbound passenger flow and an outbound passenger flow.

In some exemplary embodiments, the urban rail transit may be any one of subway, bus, or railway.

In some exemplary embodiments, passenger flows of the station in the urban rail transit line from the 1st statistical moment to the N^{th} statistical moment may be obtained from actual statistics.

At step 101, input the passenger flows from the 1st statistical moment to the N^{th} statistical moment into a trained passenger flow prediction model, to obtain a predicted passenger flow of the station in the urban rail transit line at an (N+1)^{th} statistical moment; where the passenger flow prediction model performs the processing of: generating a passenger flow matrix according to the passenger flows from the 1st statistical moment to the N^{th} statistical moment, where a first dimension of the passenger flow matrix is a time dimension, and a second dimension and a third dimension of the passenger flow matrix are spatial dimensions, and positions of the passenger flows of the station in the spatial dimensions represent a connection relationship of stations, where N is an integer greater than or equal to 2; performing a first convolution operation and a first full connection operation on the passenger flow matrix in the spatial dimensions to obtain spatial feature information; performing a second convolution operation and a second full connection operation on the passenger flow matrix in the time dimension to obtain temporal feature information; and performing a third full connection operation and normalization on the spatial feature information and the temporal feature information, to obtain predicted data of the spatial dimensions corresponding to an (N+1)^{th} statistical moment, and outputting, according to the predicted data of the spatial dimensions corresponding to the (N+1)^{th} statistical moment, the predicted passenger flow of the station in the urban rail transit line at the (N+1)^{th} statistical moment.

In some exemplary embodiments, the connection relationship of the stations includes a sequential order of stations, an adjacency relationship of stations, and an intersection relationship of stations. The intersection relationship represents that the same station is included in different lines.

In some exemplary embodiments, the passenger flow matrix is a three-dimensional matrix, a first dimension is a time dimension in which each element represents a statistical moment, a second dimension and a third dimension are spatial dimensions in which each statistical moment corresponds to a two-dimensional matrix having elements of valid or invalid values. Each element with a valid value represents a passenger flow of a certain station at the statistical moment, lines having the same station includes the same element of the two-dimensional matrix, and an element with an invalid value represents that there is no station at that position.

Two stations in an adjacency relationship in the same line are positioned adjacently in the two-dimensional matrix.

In some exemplary embodiments, each element corresponding to a position without a station is assigned a value less than 0.

An example of the two-dimensional matrix is given below. There are 3 lines in total in the following example. A 1st line includes 34 stations, such as stations 0 to 33 in the following two-dimensional matrix, which are arranged in the two-dimensional matrix according to a sequential order of the stations, and the 1st line includes two branches which have the same station, such as station 20 in the following two-dimensional matrix. A 2nd line includes 33 stations, such as stations 34 to 50, 10, and 51 to 65 in the following two-dimensional matrix, which are arranged in the two-dimensional matrix according to a sequential order of the stations, and the 1st line and the 2nd line have the same station, i.e., station 10. A 3rd line includes 17 stations, such as stations 66 to 73, 5, 74 to 76, 46, 77 to 79, and 15 in the following two-dimensional matrix, which are arranged in the two-dimensional matrix according to a sequential order of the stations, and the 1st line and the 3rd line have the same station, i.e., station 5, while the 2nd line and the 3rd line have the same station, i.e., station 46.

In the following example, each element corresponding to a position without a station is assigned a value −1.

It should be noted that, in the following example, the value of each element corresponding to a position with a station only represents a sequence number, instead of a passenger flow, of the station, and is used only for convenience of description. In an actual implementation, the value of each element corresponding to a position with a station should be assigned a value of a passenger flow of that station at that statistical moment.

$$[ \begin{matrix}- 1 & 34 & 35 & 36 & 37 & 38 & - 1 & - 1 & - 1 & 27 & - 1 & - 1 & - 1 & - 1 & - 1 & - 1 \\ - 1 & - 1 & - 1 & - 1 & - 1 & 39 & - 1 & - 1 & - 1 & 26 & - 1 & - 1 & - 1 & - 1 & - 1 & - 1 \\ - 1 & - 1 & - 1 & - 1 & - 1 & 40 & - 1 & - 1 & - 1 & 25 & - 1 & - 1 & - 1 & - 1 & - 1 & - 1 \\ - 1 & - 1 & - 1 & - 1 & - 1 & 41 & - 1 & - 1 & - 1 & 24 & - 1 & - 1 & - 1 & - 1 & - 1 & - 1 \\ - 1 & - 1 & 0 & - 1 & - 1 & 42 & - 1 & - 1 & - 1 & 23 & - 1 & - 1 & - 1 & - 1 & - 1 & - 1 \\ - 1 & - 1 & 1 & - 1 & - 1 & 43 & - 1 & - 1 & - 1 & 22 & - 1 & - 1 & - 1 & - 1 & - 1 & - 1 \\ - 1 & - 1 & 2 & - 1 & - 1 & 44 & - 1 & - 1 & - 1 & 21 & - 1 & - 1 & - 1 & - 1 & - 1 & - 1 \\ - 1 & - 1 & 3 & - 1 & - 1 & 45 & - 1 & - 1 & - 1 & 20 & 28 & 29 & 30 & 31 & 32 & 33 \\ - 1 & - 1 & 4 & 75 & 76 & 46 & 77 & 78 & - 1 & 19 & - 1 & - 1 & - 1 & - 1 & - 1 & - 1 \\ 72 & 73 & 5 & 74 & - 1 & 47 & - 1 & 79 & - 1 & 18 & - 1 & - 1 & - 1 & - 1 & - 1 & - 1 \\ 71 & - 1 & 6 & - 1 & 49 & 48 & - 1 & 15 & 16 & 17 & - 1 & - 1 & - 1 & - 1 & - 1 & - 1 \\ 70 & - 1 & 7 & - 1 & 50 & - 1 & - 1 & 14 & - 1 & - 1 & - 1 & - 1 & - 1 & - 1 & - 1 & - 1 \\ 69 & - 1 & 8 & 9 & 10 & 11 & 12 & 13 & - 1 & - 1 & - 1 & - 1 & - 1 & - 1 & - 1 & - 1 \\ 68 & - 1 & - 1 & - 1 & 51 & - 1 & - 1 & - 1 & - 1 & - 1 & - 1 & - 1 & - 1 & - 1 & - 1 & - 1 \\ 67 & - 1 & - 1 & - 1 & 52 & - 1 & - 1 & - 1 & - 1 & - 1 & - 1 & - 1 & - 1 & - 1 & - 1 & 65 \\ 66 & - 1 & - 1 & - 1 & 53 & 54 & 55 & 56 & 57 & 58 & 59 & 60 & 61 & 62 & 63 & 64\end{matrix} ]$$

In some exemplary embodiments, generating the passenger flow matrix according to the passenger flows from the 1st statistical moment to the N^{th} statistical moment includes: generating a two-dimensional first matrix corresponding to a j^{th} statistical moment according to the passenger flow of the station in the urban rail transit line at the j^{th} statistical moment, where j is an integer between 1 and N; and splicing two-dimensional first matrixes corresponding to all the statistical moments into the passenger flow matrix in the time dimension.

In some exemplary embodiments, the passenger flow matrix has a size of M×M×N, where M×M is a size of the spatial dimensions, and N is a size of the temporal dimension.

In some exemplary embodiments, N is 4.

In some exemplary embodiments, a purpose of performing the first convolution operation on the passenger flow matrix in the spatial dimensions is to extract passenger flow characteristic relationship information in adjacent spaces.

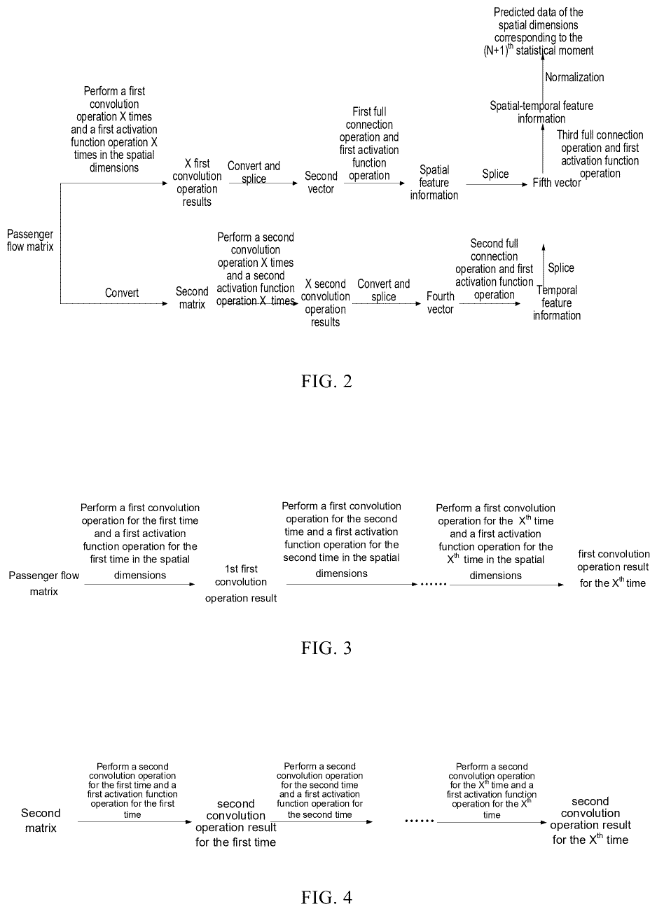

In some exemplary embodiments, as shown in FIG. 2, performing the first convolution operation and the first full connection operation on the passenger flow matrix in the spatial dimensions to obtain spatial feature information includes: performing the first convolution operation X times and a first activation function operation X times on the passenger flow matrix in the spatial dimensions to obtain X first convolution operation results, where X is an integer greater than or equal to 2; converting each first convolution operation result into a one-dimensional first vector; splicing X first vectors into a one-dimensional second vector; and performing the first full connection operation and the first activation function operation on the second vector to obtain spatial feature information.

In some exemplary embodiments, as shown in FIG. 3, performing the first convolution operation X times and the first activation function operation X times on the passenger flow matrix in the spatial dimensions to obtain X first convolution operation results includes: performing the first convolution operation for the first time and the first activation function operation for the first time on the passenger flow matrix in the spatial dimensions to obtain a first convolution operation result for the first time; and performing the first convolution operation for the (i+1)^{th} time and the first activation function operation for the (i+1)^{th} time on a first convolution operation result for the i^{th} time to obtain a first convolution operation result for the (i+1)^{th} time, where i is an integer between 1 and X−1.

In some exemplary embodiments, a convolutional kernel of the first convolution operation may have a size of A×A, for example, 2×2.

In some exemplary embodiments, performing the first convolution operation for the first time and the first activation function operation for the first time on the passenger flow matrix in the spatial dimensions to obtain the first convolution operation result for the first time includes: performing the first convolution operation for the first time on the passenger flow matrix in the spatial dimensions to obtain a first convolution operation intermediate result for the first time, and performing the first activation function operation for the first time on the first convolution operation intermediate result for the first time to obtain the first convolution operation result for the first time.

In some exemplary embodiments, performing the first convolution operation for the (i+1)^{th} time and the first activation function operation for the (i+1)^{th} time on the first convolution operation result for the i^{th} time to obtain the first convolution operation result for the (i+1)^{th} time includes: performing the first convolution operation for the (i+1)^{th} time on the first convolution operation result for the i^{th} time to obtain an first convolution operation intermediate result for the (i+1)^{th} time, and performing the first activation function operation for the (i+1)^{th} time on the first convolution operation intermediate result for the (i+1)^{th} time to obtain the first convolution operation result for the (i+1)^{th} time.

In some exemplary embodiments, each first convolution operation result has a size of M×M×N.

In some exemplary embodiments, the first vector has a size of 1×(M×N×N).

In some exemplary embodiments, converting each first convolution operation result into a one-dimensional first vector includes: splicing each first convolution operation result into a one-dimensional first vector.

In some exemplary embodiments, a splicing order of the first convolution operation result is not limited, as long as it is ensured that all the first convolution operation results are spliced in the same order.

In some exemplary embodiments, a splicing order in which X first vectors are spliced into a one-dimensional second vector is not limited.

In some exemplary embodiments, the second vector has a size of 1×(X×M×M×N).

In some exemplary embodiments, the first activation function may be a selu function.

In some exemplary embodiments, the spatial feature information has a size of 1×(X×M×M×N/4).

In some exemplary embodiments, a purpose of performing the second convolution operation on the passenger flow matrix in the time dimension is to extract passenger flow characteristic relationship information at adjacent moments.

In some exemplary embodiments, as shown in FIG. 2, performing the second convolution operation and the second full connection operation on the passenger flow matrix in the time dimension to obtain temporal feature information includes: converting the passenger flow matrix into a two-dimensional second matrix under the condition of ensuring that the time dimension is unchanged; performing the second convolution operation X times and a first activation function operation X times on the second matrix to obtain X second convolution operation results; converting each second convolution operation result into a one-dimensional third vector; splicing X third vectors into a one-dimensional fourth vector; and performing the second full connection operation and the first activation function operation on the fourth vector to obtain temporal feature information.

In some exemplary embodiments, converting the passenger flow matrix into the two-dimensional second matrix under the condition of ensuring that the time dimension is unchanged refers to a step of converting a two-dimensional matrix corresponding to each statistical moment into a one-dimensional vector, and splicing all the converted one-dimensional vectors in the time dimension. The second matrix has a size of (M×M)×N×1.

In some exemplary embodiments, as shown in FIG. 4, performing a second convolution operation X times and a first activation function operation X times on the second matrix to obtain X second convolution operation results includes: performing the second convolution operation for the first time and the first activation function operation for the first time on the second matrix to obtain a second convolution operation result for the first time; and performing the second convolution operation for the (i+1)^{th} time and the first activation function operation for the (i+1)^{th} time on a second convolution operation result for the i^{th} time to obtain a second convolution operation result for the (i+1)^{th} time, where i is an integer between 1 and X−1.

In some exemplary embodiments, performing the second convolution operation for the first time and the first activation function operation for the first time on the second matrix to obtain the second convolution operation result for the first time includes: performing the second convolution operation for the first time on the second matrix to obtain a second convolution operation intermediate result for the first time, and performing the first activation function operation for the first time on the second convolution operation intermediate result for the first time to obtain the second convolution operation result for the first time.

In some exemplary embodiments, performing the second convolution operation for the (i+1)^{th} time and the first activation function operation for the (i+1)^{th} time on the second convolution operation result for the i^{th} time to obtain the second convolution operation result for the (i+1)^{th} time includes: performing the second convolution operation for the (i+1)^{th} time on the second convolution operation result for the i^{th} time to obtain a second convolution operation intermediate result for the (i+1)^{th} time, and performing the first activation function operation for the (i+1)^{th} time on the second convolution operation intermediate result for the (i+1)^{th} time to obtain the second convolution operation result for the (i+1)^{th} time.

In some exemplary embodiments, a convolutional kernel of the second convolution operation may have a size of 1×B, for example, 1×2.

In some exemplary embodiments, converting each second convolution operation result into a one-dimensional third vector includes: splicing each second convolution operation result into a one-dimensional third vector.

In some exemplary embodiments, a splicing order of the second convolution operation result is not limited, as long as it is ensured that all the second convolution operation results are spliced in the same order.

In some exemplary embodiments, a splicing order in which X third vectors are spliced into a one-dimensional fourth vector is not limited.

In some exemplary embodiments, the fourth vector has a size of 1×(X×M×M×N).

In some exemplary embodiments, the first activation function may be a selu function.

In some exemplary embodiments, the temporal feature information has a size of 1×(X×M×M×N/4).

In some exemplary embodiments, as shown in FIG. 2, performing the third full connection operation and normalization on the spatial feature information and the temporal feature information, to obtain predicted data of the spatial dimensions corresponding to the (N+1)^{th} statistical moment includes: splicing the spatial feature information and the temporal feature information into a one-dimensional fifth vector, and performing a third full connection operation and a first activation function operation on the fifth vector to obtain spatial-temporal feature information; and performing normalization on the spatial-temporal feature information to obtain predicted data of the spatial dimensions corresponding to the (N+1)^{th} statistical moment.

In some exemplary embodiments, the spatial feature information has a size of 1×(X×M×M×N/4), and the temporal feature information has a size of 1×(X×M×M×N/4), so the fifth vector has a size of 1×(X×M×M×N/2).

In some exemplary embodiments, the spatial-temporal feature information has a size of 1×(X×M×M×N/4).

In some exemplary embodiments, performing normalization on the spatial-temporal feature information to obtain predicted data of the spatial dimensions corresponding to an (N+1)^{th} statistical moment includes: performing a second activation function operation on the spatial-temporal feature information to obtain predicted data of the spatial dimensions corresponding to the (N+1)^{th} statistical moment.

In some exemplary embodiments, the predicted data of the spatial dimensions corresponding to the (N+1)^{th} statistical moment has a size of 1×(X×M×M×N/8).

In some exemplary embodiments, the second activation function may be a sigmod function.

In some exemplary embodiments, outputting, according to the predicted data of the spatial dimensions corresponding to the (N+1)^{th} statistical moment, the predicted passenger flow of the station in the urban rail transit line at the (N+1)^{th} statistical moment refers to a step of outputting a value of an element corresponding to the station in the predicted data of the spatial dimensions corresponding to the (N+1)^{th} statistical moment, as the predicted passenger flow of the station in the urban rail transit line at the (N+1)^{th} statistical moment.

According to the passenger flow prediction method provided in the embodiments of the present disclosure, a passenger flow at a next statistical moment can be predicted based on passenger flows of a station at different statistical moments independent of other objective factors (such as weather, holidays and the like), so that the accuracy of model prediction is increased, the requirement on data sets is reduced, and the adaptability of the model is improved.

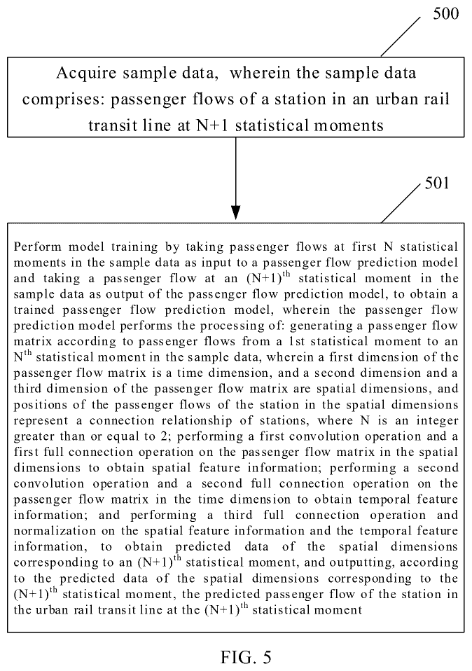

FIG. 5 is a flowchart of a model training method according to another embodiment of the present disclosure.

In a second aspect, referring to FIG. 5, another embodiment of the present disclosure provides a model training method, which includes the following steps 500 to 501.

At step 500, acquiring sample data, where the sample data includes: passenger flows of a station in an urban rail transit line at N+1 statistical moments.

In an embodiment of the present disclosure, the passenger flows at the N+1 statistical moments in the sample data are all historical statistical passenger flows.

At step 501, performing model training by taking passenger flows at first N statistical moments in the sample data as input to a passenger flow prediction model and taking a passenger flow at an (N+1)^{th} statistical moment in the sample data as output of the passenger flow prediction model, to obtain a trained passenger flow prediction model, where the passenger flow prediction model performs the processing of: generating a passenger flow matrix according to passenger flows from a 1st statistical moment to an N^{th} statistical moment in the sample data, where a first dimension of the passenger flow matrix is a time dimension, and a second dimension and a third dimension of the passenger flow matrix are spatial dimensions, and positions of the passenger flows of the station in the spatial dimensions represent a connection relationship of stations, and N is an integer greater than or equal to 2; performing a first convolution operation and a first full connection operation on the passenger flow matrix in the spatial dimensions to obtain spatial feature information; performing a second convolution operation and a second full connection operation on the passenger flow matrix in the time dimension to obtain temporal feature information; and performing a third full connection operation and normalization on the spatial feature information and the temporal feature information, to obtain predicted data of the spatial dimensions corresponding to an (N+1)^{th} statistical moment, and outputting, according to the predicted data of the spatial dimensions corresponding to the (N+1)^{th} statistical moment, the predicted passenger flow of the station in the urban rail transit line at the (N+1)^{th} statistical moment.

The processing procedure of the passenger flow prediction model is the same as that of the previous embodiments, and thus is not repeated here.

In a third aspect, an embodiment of the present disclosure provides an electronic device, including:
at least one processor; and
a memory having at least one program stored thereon which, when executed by the at least one processor, causes the at least one processor to implement any passenger flow prediction method or the model training method described above.

The processor is a device with a data processing capability, including but not limited to a central processing unit (CPU), or the like. The memory is a device with a data storage capability, including but not limited to, a random access memory (RAM, more specifically SDRAM, DDR, etc.), a read-only memory (ROM), an electrically erasable programmable read-only memory (EEPROM) or a flash memory (FLASH).

In some embodiments, the processor and the memory are connected to each other via a bus, and further connected to other components of a computing device.

In a fourth aspect, an embodiment of the present disclosure provides a readable medium having a computer program stored thereon which, when executed by a processor, causes any passenger flow prediction method or the model training method described above to be implemented.

Those of ordinary skill in the art will appreciate that all or some steps of the above described method, functional modules/units in the system and apparatus may be implemented as software, firmware, hardware, and suitable combinations thereof. In a hardware implementation, the division between the functional modules/units mentioned in the above description does not necessarily correspond to the division of physical components; for example, one physical component may have multiple functions, or one function or operation may be performed cooperatively by several physical components. Some or all physical components may be implemented as software executed by a processor, such as a CPU, a digital signal processor or microprocessor, or implemented as hardware, or implemented as an integrated circuit, such as an application specific integrated circuit. Such software may be distributed on a readable medium which may include a computer storage medium (or non-transitory medium) and a communication medium (or transitory medium). As is well known to those of ordinary skill in the art, the term computer storage medium includes volatile and nonvolatile, removable and non-removable medium implemented in any method or technology for storing information, such as computer-readable instructions, data structures, program modules or other data. The computer storage medium includes, but is not limited to, an RAM, an ROM, an EEPROM, a flash or any other memory technology, a CD-ROM, a digital versatile disk (DVD) or any other optical disk storage, a magnetic cartridge, a magnetic tape, a magnetic disk storage or any other magnetic memory, or may be any other medium used for storing the desired information and accessible by a computer. Moreover, it is well known to those ordinary skilled in the art that a communication medium typically includes a computer-readable instruction, a data structure, a program module, or other data in a modulated data signal, such as a carrier wave or other transport mechanism, and may include any information delivery medium.

The present disclosure has disclosed exemplary embodiments, and although specific terms are employed, they are used and should be interpreted merely in a generic and descriptive sense, not for purposes of limitation. In some instances, as would be apparent to one skilled in the art, features, characteristics and/or elements described in connection with a particular embodiment may be used alone or in combination with features, characteristics and/or elements described in connection with another embodiment, unless expressly stated otherwise. It will, therefore, be understood by those skilled in the art that various changes in form and details may be made therein without departing from the scope of the present disclosure as set forth in the appended claims.

1. A passenger flow prediction method, comprising:
acquiring passenger flows of a station in an urban rail transit line from a 1 st statistical moment to an N^{th} statistical moment;
inputting the passenger flows from the 1st statistical moment to the N^{th} statistical moment into a trained passenger flow prediction model, to obtain a predicted passenger flow of the station in the urban rail transit line at an (N+1)^{th} statistical moment;
wherein the passenger flow prediction model performs the processing of:
generating a passenger flow matrix according to the passenger flows from the 1st statistical moment to the N^{th} statistical moment, wherein a first dimension of the passenger flow matrix is a time dimension, and a second dimension and a third dimension of the passenger flow matrix are spatial dimensions, and positions of the passenger flows of the station in the spatial dimensions represent a connection relationship of stations, where N is an integer greater than or equal to 2;
performing a first convolution operation and a first full connection operation on the passenger flow matrix in the spatial dimensions to obtain spatial feature information;
performing a second convolution operation and a second full connection operation on the passenger flow matrix in the time dimension to obtain temporal feature information; and
performing a third full connection operation and normalization on the spatial feature information and the temporal feature information, to obtain predicted data of the spatial dimensions corresponding to the (N+1)^{th} statistical moment, and outputting, according to the predicted data of the spatial dimensions corresponding to the (N+1)^{th} statistical moment, the predicted passenger flow of the station in the urban rail transit line at the (N+1)^{th} statistical moment.

2. The passenger flow prediction method according to claim 1, wherein generating the passenger flow matrix according to the passenger flows from the 1st statistical moment to the N^{th} statistical moment comprises:
generating a two-dimensional first matrix corresponding to a j^{th} statistical moment according to the passenger flow of the station in the urban rail transit line at the j^{th} statistical moment, where j is an integer between 1 and N; and
splicing two-dimensional first matrixes corresponding to all the statistical moments into the passenger flow matrix in the time dimension.

3. The passenger flow prediction method according to claim 1, wherein performing the first convolution operation and the first full connection operation on the passenger flow matrix in the spatial dimensions to obtain spatial feature information comprises:
performing the first convolution operation X times and a first activation function operation X times on the passenger flow matrix in the spatial dimensions to obtain X first convolution operation results, where X is an integer greater than or equal to 2;
converting each first convolution operation result into a one-dimensional first vector;
splicing X first vectors into a one-dimensional second vector; and
performing the first full connection operation and the first activation function operation on the second vector to obtain the spatial feature information.

4. The passenger flow prediction method according to claim 3, wherein performing the first convolution operation X times and the first activation function operation X times on the passenger flow matrix in the spatial dimensions to obtain X first convolution operation results comprises:
performing the first convolution operation for the first time and the first activation function operation for the first time on the passenger flow matrix in the spatial dimensions to obtain a first convolution operation result for the first time; and
performing the first convolution operation for the (i+1)^{th} time and the first activation function operation for the (i+1)^{th} time on a first convolution operation result for the i^{th} time to obtain a first convolution operation result for the (i+1)^{th} time, where i is an integer between 1 and X−1.

5. The passenger flow prediction method according to claim 1, wherein performing the second convolution operation and the second full connection operation on the passenger flow matrix in the time dimension to obtain temporal feature information comprises:
converting the passenger flow matrix into a two-dimensional second matrix under the condition of ensuring that the time dimension is unchanged;
performing the second convolution operation X times and a first activation function operation X times on the second matrix to obtain X second convolution operation results;
converting each second convolution operation result into a one-dimensional third vector;
splicing X third vectors into a one-dimensional fourth vector; and
performing the second full connection operation and the first activation function operation on the fourth vector to obtain the temporal feature information.

6. The passenger flow prediction method according to claim 5, wherein performing the second convolution operation X times and the first activation function operation X times on the second matrix to obtain X second convolution operation results comprises:
performing the second convolution operation for the first time and the first activation function operation for the first time on the second matrix to obtain a second convolution operation result for the first time; and
performing the second convolution operation for the (i+1)^{th} time and the first activation function operation for the (i+1)^{th} time on a second convolution operation result for the i^{th} time to obtain a second convolution operation result for the (i+1)^{th} time, where i is an integer between 1 and X−1.

7. The passenger flow prediction method according to claim 1, wherein performing the third full connection operation and normalization on the spatial feature information and the temporal feature information, to obtain predicted data of the spatial dimensions corresponding to the (N+1)^{th} statistical moment comprises:
splicing the spatial feature information and the temporal feature information into a one-dimensional fifth vector, and performing the third full connection operation and a first activation function operation on the fifth vector to obtain spatial-temporal feature information; and
performing normalization on the spatial-temporal feature information to obtain predicted data of the spatial dimensions corresponding to the (N+1)^{th} statistical moment.

8. A model training method, comprising:
acquiring sample data, wherein the sample data comprises: passenger flows of a station in an urban rail transit line at N+1 statistical moments;
performing model training by taking passenger flows at first N statistical moments in the sample data as input to a passenger flow prediction model and taking a passenger flow at an (N+1)^{th} statistical moment in the sample data as output of the passenger flow prediction model, to obtain a trained passenger flow prediction model,
wherein the passenger flow prediction model performs the processing of:
generating a passenger flow matrix according to passenger flows from a 1st statistical moment to an N^{th} statistical moment in the sample data, wherein a first dimension of the passenger flow matrix is a time dimension, and a second dimension and a third dimension of the passenger flow matrix are spatial dimensions, and positions of the passenger flows of the station in the spatial dimensions represent a connection relationship of stations, where N is an integer greater than or equal to 2;
performing a first convolution operation and a first full connection operation on the passenger flow matrix in the spatial dimensions to obtain spatial feature information;
performing a second convolution operation and a second full connection operation on the passenger flow matrix in the time dimension to obtain temporal feature information; and
performing a third full connection operation and normalization on the spatial feature information and the temporal feature information, to obtain predicted data of the spatial dimensions corresponding to an (N+1)^{th} statistical moment, and outputting, according to the predicted data of the spatial dimensions corresponding to the (N+1)^{th} statistical moment, the predicted passenger flow of the station in the urban rail transit line at the (N+1)^{th} statistical moment.

9. An electronic device, comprising:
at least one processor; and
a memory having at least one program stored thereon which, when executed by the at least one processor, causes the at least one processor to implement the passenger flow prediction method according to claim 1.

10. (canceled)

11. An electronic device, comprising:
at least one processor; and
a memory having at least one program stored thereon which, when executed by the at least one processor, causes the at least one processor to implement the model training method according to claim 8.

12. A readable medium having a computer program stored thereon which, when executed by a processor, causes the passenger flow prediction method according to claim 1 to be implemented.

13. A readable medium having a computer program stored thereon which, when executed by a processor, causes the model training method according to claim 8 to be implemented.
